(19) United States
(12) Patent Application Publication
(10) Pub. No.: US 2005/0238938 A1
(43) Pub. Date: Oct. 27, 2005

(54) Membranes for fuel cells

(76) Inventor: Raj G. Rajendran, Hockessin, DE (US)

Correspondence Address: E I du Pont de Nemours and Company;Legal - Patents, 4417 Lancaster Pike, Wilmington, DE, 19898, US

(21) Appl. No.: 10/527,043

(22) PCT Filed: Sep. 12, 2003
(86) PCT No.: PCT/US03/29160

§ 371 Date: Mar. 8, 2005

Related U.S. Application Data
(60) Provisional application No. 60/410,766, filed on Sep. 13, 2002.

(51) Int. Cl. H01M 8/10

(52) U.S. Cl. 429/33; 429/30

(57) ABSTRACT

The invention provides a direct methanol fuel cell comprising: (a) a solid fluorinated polymer electrolyte membrane having an ion exchange ratio (IXR) of at least about 17, wherein the solid polymer electrolyte membrane has a first surface and a second surface; and (b) at least one catalyst layer present on each of the first and second surfaces of the solid polymer electrolyte membrane; wherein the fuel cell is operated at a temperature of less than 60° C.; and wherein the methanol cross-over rate is reduced by at least about 20%; and the power output is equal to or increased up to about 15%, versus a fuel cell comprising a solid fluorinated polymer electrolyte membrane having the same thickness, and an ion exchange ratio (IXR) of about 15.

### FIELD OF THE INVENTION

This invention relates to membranes and their use in electrode assemblies (MEA) for fuel cells.

### BACKGROUND OF THE INVENTION

Fuel cells are devices that convert fuel and oxidant to electrical energy. Electrochemical cells generally include an anode electrode and a cathode electrode separated by an electrolyte. A well-known use of electrochemical cells is in a stack for a fuel cell that uses a proton exchange membrane (hereafter “PEM”) as the electrolyte. In such a cell, a reactant or reducing fuel such as hydrogen is supplied to the anode electrode, and an oxidant such as oxygen or air is supplied to the cathode electrode. The hydrogen electrochemically reacts at a surface of the anode electrode to produce hydrogen ions and electrons. The electrons are conducted to an external load circuit and then returned to the cathode electrode, while hydrogen ions transfer through the electrolyte to the cathode electrode, where they recombine with the oxidant to produce water and release thermal energy.

Most efficient fuel cells use pure hydrogen as the fuel and oxygen as the oxidant. Unfortunately, use of pure hydrogen has a number of known disadvantages, not the least of which is the relatively high cost, and storage considerations. Consequently, attempts have been made to operate fuel cells using other than pure hydrogen as the fuel.

For example, attempts have been made to use hydrogen-rich gas mixtures obtained from steam reforming methanol as a fuel cell feed. The methanol fuel cell is a potentially attractive power source for vehicles and other low to medium power applications such as uninterruptible power supplies and lawn mowers, in the military as well as the commercial sectors. Benefits to be derived from use of methanol fuel cells as power sources include dramatic reductions in emissions of air pollutants, reduction in the nation's dependence on imported petroleum since methanol can be made from indigenous fuels such as coal and natural gas and also from renewable sources such as wood and biomass, and an overall increase in vehicle energy efficiency.

Methanol fuel cell systems currently under development use low-temperature steam reformers in conjunction with fuel cell stacks to generate power from methanol in indirect systems. By “indirect” it is meant that methanol fuel is processed (by a reformer) before it is introduced into the fuel cell stack. However, the system can be vastly simplified, and the overall system thermal efficiency can be improved if direct anodic oxidation of methanol is achieved at low polarization. A direct methanol fuel cell will also be preferred for vehicular applications because its weight, volume, start-up and load-following characteristics should be more attractive than the more complex indirect systems.

One drawback to direct methanol PEMFC (DMPEMFC) is that the currently available PEM electrolytes do not totally exclude methanol. Instead, methanol permeates from the anode chamber of the PEMFC across the membrane, to the cathode catalyst, and reacts with reactant air (O₂), resulting in a parasitic loss of methanol fuel and reduced fuel cell voltage. Performance losses of 40-70 mV at a given current density have been observed at the cathode of PEMFCs with a direct methanol feed (Potje-Kamloth et al., Abstract No. 105, Extended Abstracts, Vol. 92-2, Fall Meeting of the Electrochemical Society, 1992). Most recently, Kuver et al. in J. Power Sources 52, 77 (1994) have observed a loss of at least 100 mV for the air (O₂) electrode when operated in a gas-feed DMPEMFC. This translates into an approximately 10% decrease in air (O₂) cathode performance output as compared to a cell operating without direct methanol feed. To compensate for inefficiencies due to methanol crossover, DMPEMFCs must be oversized, resulting in a larger, heavier and more expensive fuel cell. To be competitive, these parameters must be minimized.

### SUMMARY OF THE INVENTION

In accordance with the invention, there is provided a direct methanol fuel cell comprising:
(a) a solid fluorinated polymer electrolyte membrane having an ion exchange ratio (IXR) of at least about 17, wherein the solid polymer electrolyte membrane has a first surface and a second surface; and
(b) at least one catalyst layer present on each of the first and second surfaces of the solid polymer electrolyte membrane; wherein the fuel cell is operated at a temperature of less than 60° C.; and wherein the methanol cross-over rate is reduced by at least about 20%; and the power output is equal to or increased up to about 15%, versus a fuel cell comprising a solid fluorinated polymer electrolyte membrane having the same thickness, and an ion exchange ratio (IXR) of about 15. Typically, the fluorinated polymer is a perfluorinated sulfonic acid polymer sold by E. I. duPont de Nemours and Company under the tradename of Nafion®.

In this embodiment, the invention further provides a direct methanol fuel cell, wherein the IXR is typically about 17 to about 29, and more typically 19 to about 23.

### BRIEF DESCRIPTION OF THE DRAWINGS

FIG. 1 is a schematic illustration of a single cell assembly.

FIG. 2 is a schematic illustration of a typical DMFC test station.

FIG. 3 is a graph showing the performance of a DMFC using membranes having ion exchange ratios of 23 and 15 at an operating temperature of 28° C.

FIG. 4 is a graph showing the performance of a DMFC using membranes having ion exchange ratios of 23 and 15 at an operating temperature of 60° C.

### DETAILED DESCRIPTION OF THE INVENTION

It has been discovered that at operating temperatures of less than 60° C., typically less than 55° C., more typically less than 50° C., still more typically less than 40° C., and most typically between 20 and 40° C., a direct methanol fuel cell's efficiency is significantly improved by using an ion exchange membrane comprising perfluorinated polymers having an ion exchange ratio (IXR) of at least about 17, more typically about 17 to about 29, when compared to fuel cells wherein the membrane has the same thickness, and comprises a perfluorinated polymer having an ion exchange ratio (IXR) of at least about 15. Methanol cross-over was reduced without a reduction in power output. Power output is found to be equal to or increased up to 15%, typically increased by at least about 5%, and more typically increased by about 10 to 15%, at temperatures of less than 60° C. The methanol cross-over rate is reduced by at least about 20%; typically reduced by at least about 40%, and more typically reduced by 50 to about 75%. Methanol cross-over is dependant on thickness. The thickness of the membrane is typically about 75μ to about 250μ, more typically about 125μ to about 250μ. For a membrane having a thickness of about 250μ, and an IXR of 23, ie., an equivalent weight (EW) of 1500, a reduction of about 75% in methanol cross-over may be achieved. For a similar membrane having a thickness of about 177.8 μL, a reduction of about 60% in methanol cross-over may be achieved.

Membrane:

The solid fluorinated polymer electrolyte membrane having an IXR of about 17 to about 29 comprises an ion exchange polymer that is typically a highly fluorinated ion-exchange polymer. “Highly fluorinated” means that at least 90% of the total number of univalent atoms in the polymer are fluorine atoms. Most typically, the polymer is perfluorinated. It is also typical for use in fuel cells for the polymers to have sulfonate ion exchange groups. The term “sulfonate ion exchange groups” is intended to refer to either sulfonic acid groups or salts of sulfonic acid groups, typically alkali metal or ammonium salts. For applications where the polymer is to be used for proton exchange as in fuel cells, the sulfonic acid form of the polymer is typical. If the polymer in the electrocatalyst coating composition is not in sulfonic acid form when used, a post treatment acid exchange step will be required to convert the polymer to acid form prior to use.

Typically, the ion exchange polymer employed comprises a polymer backbone with recurring side chains attached to the backbone with the side chains carrying the ion exchange groups. Possible polymers include homopolymers or copolymers of two or more monomers. Copolymers are typically formed from one monomer which is a nonfunctional monomer and which provides carbon atoms for the polymer backbone. A second monomer provides both carbon atoms for the polymer backbone and also contributes the side chain carrying the cation exchange group or its precursor, e.g., a sulfonyl halide group such a sulfonyl fluoride (—SO₂F), which can be subsequently hydrolyzed to a sulfonate ion exchange group. For example, copolymers of a first fluorinated vinyl monomer together with a second fluorinated vinyl monomer having a sulfonyl fluoride group (—SO₂F) can be used. Possible first monomers include tetrafluoroethylene (TFE), hexafluoropropylene, vinyl fluoride, vinylidine fluoride, trifluoroethylene, chlorotrifluoroethylene, perfluoro (alkyl vinyl ether), and mixtures thereof. Possible second monomers include a variety of fluorinated vinyl ethers with sulfonate ion exchange groups or precursor groups which can provide the desired side chain in the polymer. The first monomer may also have a side chain which does not interfere with the ion exchange function of the sulfonate ion exchange group. Additional monomers can also be incorporated into these polymers if desired.

Typical polymers include a highly fluorinated, most typically a perfluodnated, carbon backbone with a side chain represented by the formula —(O—CF₂CFR_{f})ₐ—O—CF₂CFR′_{f}SO₃Y, wherein R_{f} and R′_{f} are independently selected from F, Cl or a perfluorinated alkyl group having 1 to 10 carbon atoms, a=0, 1 or 2, and Y is H, an alkali metal, or NH₄. The typical polymers include, for example, polymers disclosed in U.S. Pat. No. 3,282,875 and in U.S. Pat. Nos. 4,358,545 and 4,940,525. One typical polymer comprises a perfluorocarbon backbone and the side chain is represented by the formula —O—CF₂CF(CF₃)—O—CF₂CF₂SO₃H. Polymers of this type are disclosed in U.S. Pat. No. 3,282,875 and can be made by copolymerization of tetrafluoroethylene (TFE) and the perfluorinated vinyl ether CF₂═CF—O—CF₂CF(CF₃)—O—CF₂CF₂SO₂F, perfluoro(3,6-dioxa-4-methyl-7-octenesulfonyl fluoride) (PDMOF), followed by conversion to sulfonate groups by hydrolysis of the sulfonyl fluoride groups and ion exchanging to convert to the acid, also known as the proton form. One typical polymer of the type disclosed in U.S. Pat. Nos. 4,358,545 and 4,940,525 has the side chain —O—CF₂CF₂SO₃H. This polymer can be made by copolymerization of tetrafluoroethylene (TFE) and the perfluorinated vinyl ether CF₂═CF—O—CF₂CF₂SO₂F, perfluoro(3-oxa-4-pentenesulfonyl fluoride) (POPF), followed by hydrolysis and acid exchange.

For perfluorinated polymers of the type described above, the ion exchange capacity of a polymer can be expressed in terms of ion exchange ratio (“IXR”). Ion exchange ratio is defined as number of carbon atoms in the polymer backbone in relation to the ion exchange groups. A wide range of IXR values for the polymer is possible. Within the range of less than about 33, IXR can be varied as desired for the particular application. The ion exchange capacity of a polymer is often expressed in terms of equivalent weight (EW). For the purposes of this application, equivalent weight (EW) is defined to be the weight of the polymer in acid form required to neutralize one equivalent of sodium hydroxide. In the case of a sulfonate polymer where the polymer has a perfluorocarbon backbone and the side chain is —O—CF2-CF(CF3)—O—CF2-CF2-SO3H (or a salt thereof), the equivalent weight range which corresponds to an IXR of about 17 to about 29 is about 1200 EW to about 1800 EW. Typically the polymer has an EW of 1500 corresponding to an IXR of 23. IXR for this polymer can be related to equivalent weight using the formula: 50 IXR+344=EW. While the same IXR range is used for sulfonate polymers disclosed in U.S. Pat. Nos. 4,358,545 and 4,940,525, e.g., the polymer having the side chain —O—CF2CF2SO3H (or a salt thereof), the equivalent weight is somewhat lower because of the lower molecular weight of the monomer unit containing a cation exchange group. For the preferred IXR range of about 17 to about 29, the corresponding equivalent weight range is about 1028 EW to about 1628 EW. IXR for this polymer can be related to equivalent weight using the formula: 50 IXR+178=EW.

In addition, the membrane may be made of a blend of two or more polymers such as two or more highly fluorinated polymers having different ion exchange groups and/or different ion exchange capacities.

The thickness of the membrane can be varied as desired for a particular electrochemical cell application. Typically, the thickness of the membrane is generally less than about 250 μm, preferably in the range of about 25 μm to about 150 μm. When the membrane is a monolithic high-IXR membrane, thickness is preferably no more than about 100 μm.

The membrane may optionally include a porous support for the purposes of improving mechanical properties, for decreasing cost and/or other reasons. The porous support of the membrane may be made from a wide range of components. The porous support of the present invention may be made from a hydrocarbon such as a polyolefin, e.g., polyethylene, polypropylene, polybutylene, copolymers of those materials, and the like. Perhalogenated polymers such as polychlorotrifluoroethylene may also be used. For resistance to thermal and chemical degradation, the support preferably is made of a highly fluorinated polymer, most preferably perfluorinated polymer.

For example, the polymer for the porous support can be a microporous film of polytetrafluoroethylene (PTFE) or a copolymer of tetrafluoroethylene with
CF₂=CFCₙF₂ₙ₊₁(n=1 to 5) or 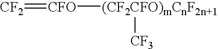
(m=0 to 15, n=1 to 15).

Microporous PTFE films and sheeting are known which are suitable for use as a support layer. For example, U.S. Pat. No. 3,664,915 discloses uniaxially stretched film having at least 40% voids. U.S. Pat. Nos. 3,953,566, 3,962,153 and 4,187,390 disclose porous PTFE films having at least 70% voids.

Alternatively, the porous support may be a fabric made from fibers of the polymers discussed above woven using various weaves such as the plain weave, basket weave, leno weave, or others.

A membrane can be made using the porous support by coating the ion exchange polymer, preferably the cation exchange polymer, on the support so that the coating is on the outside surfaces as well as being distributed through the internal pores of the support. This may be accomplished by impregnating the porous support solution/dispersion with the cation exchange polymer or cation exchange polymer precursor using a solvent which is not harmful to the polymer of the support under the impregnation conditions and which can form a thin, even coating of the cation exchange polymer on the support. For example, for applying a coating of perfluorinated sulfonic acid polymer to a microporous PTFE support, a 1-10 weight percent solution/dispersion of the polymer in water mixed with sufficient amount of a polar organic solvent can be used. The support with the solution/dispersion is dried to form the membrane.

Other forms of reinforced membranes include the pTFE-yarn embedded type and the pTFE-fibril dispersed type dispersed uniformly in an ion-exchange resin as disclosed in 2000 Fuel Cell Seminar (Oct. 30 to Nov. 2, 2000, Portland, Oreg., USA) Abstracts p-23.

While the general formulae above are representative of groups of polymers they are not intented to limit the scope of the invention.

Fuel Cell:

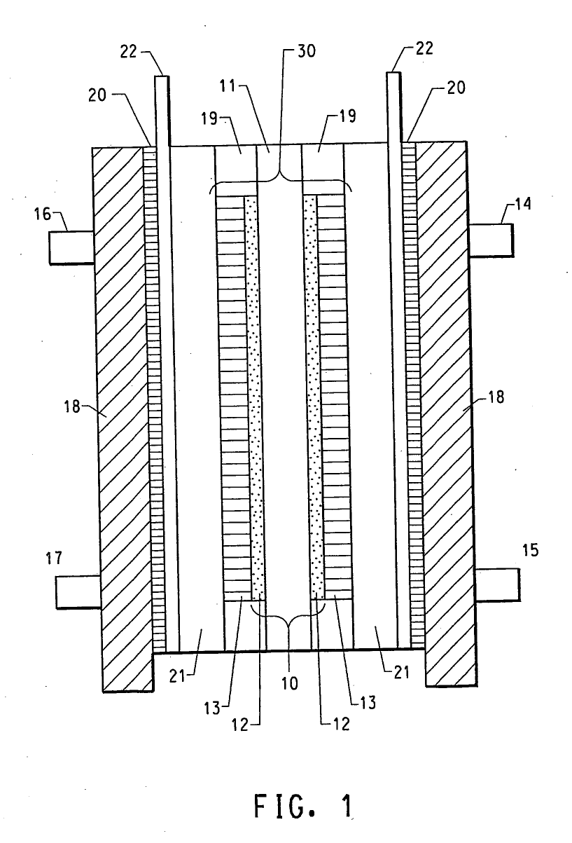

As shown in FIG. 1, the fuel cell comprises a catalyst coated membrane (CCM) (10) in combination with a gas diffusion backing (GDB)
(13) to form an unconsolidated membrane electrode assembly (MEA). The catalyst coated membrane (10) comprises a ion exchange polymer membrane (11) discussed above and catalyst layers or electrodes (12) formed from a electrocatalyst coating composition
   Catalyst Coated Membrane (CCM):

A variety of techniques are known for CCM manufacture which apply an electrocatalyst coating composition similar to that described above onto the solid fluorinated polymer electrolyte membrane. Some known methods include spraying, painting, patch coating and screen, decal, pad orflexographic printing.

In one embodiment of the invention, the MEA (30) may be prepared by thermally consolidating the gas diffusion backing (GDB) with a CCM at a temperature of under 200° C., preferably 140-160° C. The CCM may be made of any type known in theart. In this embodiment, an MEA comprises a solid polymer electrolyte (SPE) membrane with a thin catalyst- binder layer disposed thereon. The catalyst may be supported (typically on carbon) or unsupported. In one method of preparation, a catalyst film is prepared as a decal by spreading the catalyst ink on a flat release substrate such as Kapton® polyimide film (available from the DuPont Company). After the ink dries, the decal is transferred to the surface of the SPE membrane by the application of pressure and heat, followed by removal of the release substrate to form a catalyst coated membrane (CCM) with a catalyst layer having a controlled thickness and catalyst distribution. Alternatively, the catalyst layer is applied directly to the membrane, such as by printing, and then the catalyst film is dried at a temperature not greater than 200° C.

The CCM, thus formed, is then combined with a GDB to form the MEA of the present invention. The MEA is formed, by layering the CCM and the GDB, followed by consolidating the entire structure in a single step by heating to a temperature no greater than 200° C., preferably in the range of 140-160° C., and applying pressure. Both sides of the MEA can be formed in the same manner and simultaneously. Also, the composition of the catalyst layer and GDB could be different on opposite sides of the membrane.

### EXAMPLES

CCM Preparation Procedure:

The cathode catalyst dispersion was prepared in a Eiger® bead mill, manufactured by Eiger Machinery Inc., Grayslake, Ill. 60030, containing 80 ml 1.0-1.25 micron zirconia grinding media. 105 grams Platinum black catalyst powder (obtained from Colonial Metals, Elkton, Md.) and 336 grams of 3.5 wt % Nafion® solution (the polymer resin used in such a solution was typically of 930EW polymer and was in the sulfonyl fluoride form) were mixed and charged into the mill and dispersed for 2 hours. Material was withdrawn from the mill and particle size was measured. The ink was tested to ensure that the particle size was under 1-2 micron and the % solids in the range of 26%. The catalyst decal was prepared by drawing down the catalyst ink to a dimension of 5 cm×5 cm (to give a total area of 25 cm²) on a 10 cm×10 cm piece of 3 mil thick kapton® polyimide film manufactured by E.I. duPont de Nemours & Co., Wilmington, Del. A wet coating thickness of 5 mil (125 microns) typically resulted in a catalyst loading of 4 to 5 mg Pt/cm² in the final CCM. Anode decals were prepared using a procedure similar to that described above, except that in the catalyst dispersion, the Platinum black catalyst was replaced by a 1:1 atomic ratio Platinum/Ruthenium black catalyst powder (obtained from Johnson Mathey N.J.). The CCM was prepared by a decal transfer method. A piece of wet Nafion® N117 membrane (4″×4″) in the H⁺ form was used for CCM preparation. The membrane was sandwiched between two anode and cathode catalyst coated decals. Care was taken to ensure that the coatings on the two decals were registered with each other and were positioned facing the membrane. The entire assembly was introduced between two pre-heated (to 145 C) 8″×8″ plates of a hydraulic press and the plates of the press were brought together without wasting much time until a pressure of 5000 lbs was reached. The sandwich assembly was kept under pressure for ˜2 mins and then the press in cooled for ˜2 mins (viz., till it reached a temperature of <60° C.) under same pressure. Then the assembly was removed from the press and the Kapton® films were slowly peeled off from the top of the membrane showing that the catalyst coating had been transferred to the membrane. The CCM was immersed in a tray of water (to ensure that the membrane was completely wet) and carefully transferred to a zipper bag for storage and future use.

Chemical Treatment of CCMs

The CCMs were chemically treated in order to convert the ionomer in the catalyst layer from the —SO₂F form to the proton —SO₃H form. This requires a hydrolysis treatment followed by an acid exchange procedure. The hydrolysis of the CCMs was carried out in a 20 wt % NaOH solution at 80° C. for 30 min. The CCM's were placed between Teflon® mesh, manufactured by DuPont, and placed in the solution. The solution was stirred to assure uniform hydrolyses. After 30 minutes in the bath, the CCM's were removed and rinsed completely with fresh Dl water to remove all the NaOH.

Acid exchange of the CCMs that were hydrolyzed in the previous step was done in 15 wt % Nitric Acid Solution at a bath temperature of 65° C. for 45 minutes. The solution was stirred to assure uniform acid exchange. This procedure was repeated in a second bath containing 15 wt % Nitric acid solution at 65° C. for another 45 minutes.

The CCMs were then rinsed in flowing Dl water for 15 minutes at room temperature to ensure removal of all the residual acid and finally in a water bath at 65° C. for 30 minutes. They were then packaged wet and labeled. The CCM (10) comprised a Nafion® perfluorinated ion exchange membrane (11); and electrodes (12), prepared from a platinum/ruthenium black catalyst and Nafion® binder on the anode side, and a platinum black catalyst and Nafion® binder on the cathode side.

### Example 1

A 7 mil Nafion® membrane having an IXR of 23 (EW of 1500), was evaluated for fuel cell performance and methanol cross-over in a cell employing a membrane electrode assembly (MEA) of the type depicted in FIG. 1. A catalyst coated membrane (CCM) prepared as described above was loosely attached in a single cell hardware (purchased from Fuel Cell Technologies, Los Alamos, N. Mex.) with ELAT™ carbon cloths, purchased from E-Tek, Natick, Mass. on Pt—Ru black electrode side (microporous layer coated on single side and facing the catalyst layer) and Pt black electrode side (microporous layer coated on double side and thick layer facing the catalyst layer). The active area of the single cell hardware was 25 cm². The cell assembly was attached to the fuel cell test equipment.

Fuel cell performance was evaluated using the following procedure: FIG. 1 schematically illustrates a single cell assembly. Fuel cell test measurements were made employing a single cell test assembly obtained from Fuel Cell Technologies Inc, New Mexico. As shown in FIG. 1, the MEA (30) comprised the CCM (10) sandwiched between two sheets of the GDB (13) (taking care to ensure that the GDB covered the catalyst coated area on the CCM). The anode and cathode gas diffusion backings (13) were ELAT gas diffusion backings with microporous layer coated single side in the case of anode GDB and double side microporous layer coated for cathode side which is purchased from E-Tek Inc., Natick, Mass. The microporous layer was disposed toward the catalyst side. A glass fiber reinforced silicone rubber gasket (19) (Furan—Type 1007, obtained from Stockwell Rubber Company), cut to shape to cover the exposed area of the membrane of the CCM, was placed on either side of the CCM/GDB assembly (taking care to avoid overlapping of the GDB and the gasket material). The entire sandwich assembly was assembled between the anode and cathode flow field graphite plates (21) of a 25 cm² standard single cell assembly (obtained from Fuel Cell Technologies Inc., Los Alamos, N. Mex.). The test assembly shown in FIG. 1 was also equipped with anode inlet (14), anode outlet (15), cathode gas inlet (16), cathode gas outlet (17), aluminum end blocks (18), tied together with tie rods (not shown), electrically insulating layer (20), and gold plated current collectors (22). The bolts on the outer plates (not shown) of the single cell assembly were tightened with a torque wrench to a force of 1.5 ft.lb.

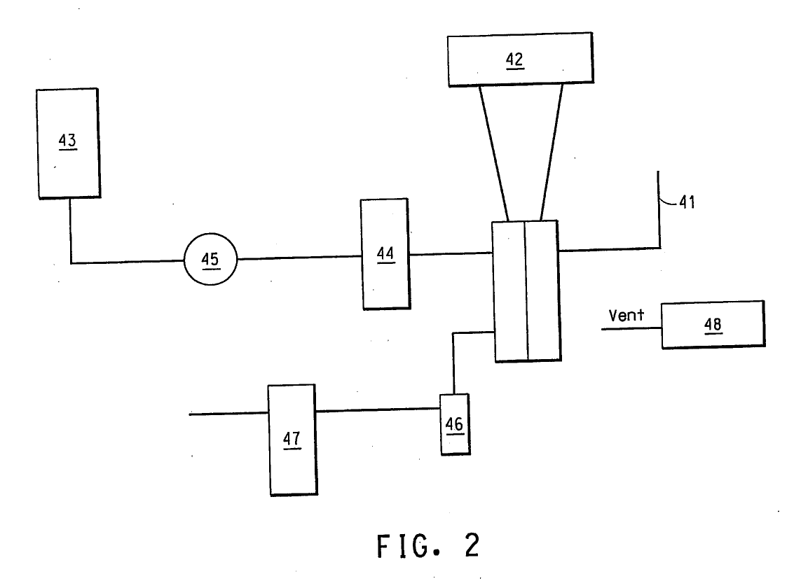

The single cell assembly was then connected to the fuel cell test station, a schematic illustration of which is shown in the FIG. 2. The components in a test station include a supply of air for use as cathode gas (41); a load box to regulate the power output from the fuel cell (42); a MeOH solution tank to hold the feed anolyte solution (43); a heater to pre-heat the MeOH solution before it enters the fuel cell (44); a liquid pump to feed the anolyte solution to the fuel cell at the desired flow rate (45); a condenser to cool the anolyte exit from the cell from the cell temperature to room temperature (46) and a collection bottle to collect the spent anolyte solution (47). The cathode exit gas is typically fed through a gas analyzer (48) (Model VIA 510, Horiba Instruments Inc., USA Horiba,) to determine quantitatively the amount of CO₂ that is being formed at the cathode as a result of oxidation of methanol that permeated through the membrane.

With the cell at room temperature, 1 M MeOH solution and air were introduced into the anode and cathode compartments respectively through inlets (14) and (16) of the cell at the rates of 5 cc/min and 500 cc/min respectively to the anode and cathode compartments. The temperature of the single cell was slowly raised till it reached 28° C. Typically, a current-voltage polarization curve was recorded. This comprised of recording the current output from the cell as the voltage was stepped down in 50 mV steps starting from the open circuit voltage (OCV) down to 0.15 V and back up to OCV. The voltage was held constant in each step for 20 seconds to allow for the current output from the cell to stabilize.

An aqueous solution of 1 M methanol was passed over the anode side and ambient pressure air at room temperature was passed over the cathode side. The cell was heated to 28° C. The current flowing across the cell which was a measure of the fuel cell performance was measured and recorded by scanning the potential from 0 volt to 0.8 V. The cell power density (W/cm²) is another performance measure, which was calculated from the equation, Power Density=Cell current density×Cell voltage.

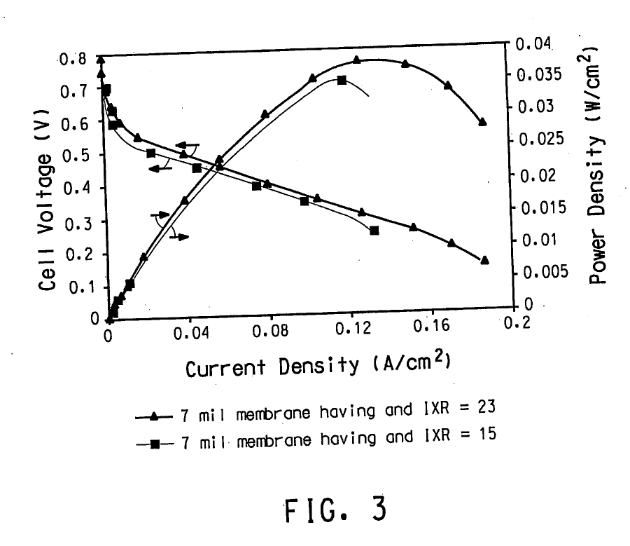

As a control, a similar measurement was done using a Nafion® N117 membrane manufactured by DuPont. The data is shown in FIG. 3.

Methanol Cross-Over Determination:

The methanol crossover or permeability of methanol through the membrane was determined by measuring the CO₂ that exited the cathode vent with the help of an infrared (1R) gas analyzer. Methanol transported across the membrane was completely oxidized to CO₂ in the presence of O₂ at the cathode. A Non-Dispersive Infrared Analyzer (Model VIA 510, Horiba Instruments Inc., USA) was used to measure the CO₂ quantitatively in the cathodic exit gas stream. The same equipment and experimental conditions described above were employed to determine the methanol crossover. The volume percent of CO₂ measured as above was converted into equivalent crossover current densities. 7 and 10 mil thick membranes as shown in Table 1 were chosen for this study. The CO₂ content for a standard Nafion® membrane (N117) was also measured as a control. The methanol crossover data for the membranes of the invention relative to Nafion® N117 are reported in Table 1.

TABLE 1
Methanol Crossover Current Density

| | Relative | Methanol |
|---|---|---|
| | Methanol | Crossover |
| Membrane | Crossover (%) | Reduction (%) |
| N117 | 100 | — |
| (7 mil, IXR = 15) | | |
| 7 mil, IXR = 23 | 40 | 60% |
| 10 mil, IXR = 23 | 25 | 75% |

### Example 2

Example 1 was repeated with the following exception: the cell temperature was raised to 38° C. The data are shown in Table 2.

TABLE 2

| | | 38° C. data, 10 cm² Graphite cell | | | |
|---|---|---|---|---|---|
| | | hardware | | | |
| | Cell | Relative MeOH | | Power Density | |
| Membrane | Reistance | Crossover (%) | | (mW/cm²) | |
| Type | (ohmcm²) | 1M Molar | 2M Molar | 1M MeOH | 2 MeOH |
| N117 | 0.22 | 100 | 100 | 30 | 35 |
| (7 mil, | | | | | |
| IXR = 15) | | | | | |
| 5 mil, | 0.37-0.46 | 50 | 48 | 35 | 31 |
| IXR = 23 | | | | | |

### Example 3

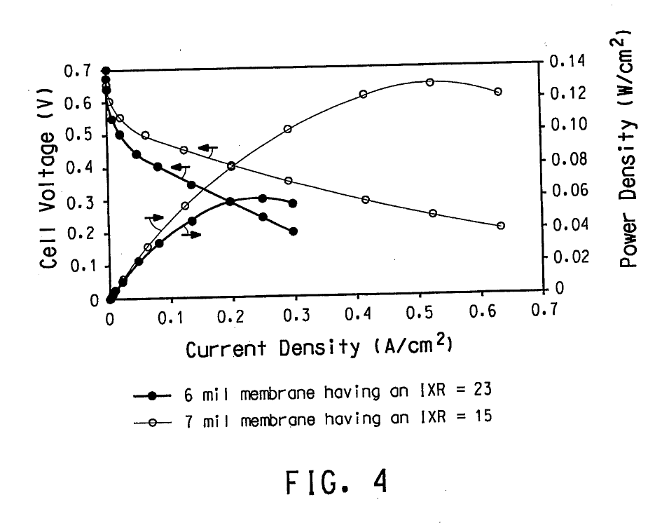

A 6.0 mil Nafion® membrane having an IXR=23 (EW of 1500) was evaluated for fuel cell performance and methanol cross-over in a cell employing a membrane electrode assembly (MEA) of the type depicted in FIG. 1. A catalyst coated membrane (CCM) prepared as described above was loosely attached in a single cell hardware (purchased from Fuel Cell Technologies, Los Alamos, N. Mex.) with a plain Zoltek carbon cloth (purchased from Zoltek Corporation, St Louis, Mo.) facing Pt—Ru black electrode side and ELAT™ carbon cloth, purchased from E-Tek, Natick, Mass. (microporous layer coated on single side and facing the catalyst layer) on Pt black electrode side. 1 M MeOH (25 cc/min) was fed in the anode side and 3000 cc/min air was fed into the cathode chamber and the cell was heated to 60° C. in the test equipment described above. The performance was recorded as detailed in the example 1, which is shown in FIG. 4. Although the membrane (6 mil, IXR=23,1500EW) reduces the methanol crossover compared to the Nafion® N117 membrane, it delivers poor power density as a result of higher membrane resistance at 60° C.

1. A direct methanol fuel cell comprising:
(a) a solid fluorinated polymer electrolyte membrane having an ion exchange ratio (IXR) of at least about 17, wherein the solid polymer electrolyte membrane has a first surface and a second surface; and
(b) at least one catalyst layer present on each of the first and second surfaces of the solid polymer electrolyte membrane; wherein the fuel cell is operated at a temperature of less than 60° C.; and wherein the methanol cross-over rate is reduced by at least about 20%; and the power output is equal to or increased up to about 15%, versus a fuel cell comprising a solid fluorinated polymer electrolyte membrane having the same thickness, and an ion exchange ratio (IXR) of about 15.

2. The direct methanol fuel cell of claim 1 wherein IXR is 17 to 29.

3. The direct methanol fuel cell of claim 2, wherein IXR is 19 to 23.

4. The direct methanol fuel cell of claim 3, wherein IXR is 23.

5. The direct methanol fuel cell of claim 1, wherein the temperature is about 50 to about 55° C.

6. The direct methanol fuel cell of claim 1, wherein the temperature is about 40 to about 50° C.

7. The direct methanol fuel cell of claim 1, wherein the temperature is about 20 to about 40° C.

8. The direct methanol fuel cell of claim 1, wherein the power output is increased by about 5 to about 15%.

9. The direct methanol fuel cell of claim 8, wherein the power output is increased by about 10 to about 15%.

10. The direct methanol fuel cell of claim 1, wherein the thickness of the membrane is 175μ, the IXR is 23, and methanol cross-over rate is reduced by 60%.

11. The direct methanol fuel cell of claim 1, wherein the thickness of the membrane is 250μ, the IXR is 23, and methanol cross-over rate is reduced by 75%.

12. The direct methanol fuel cell of claim 1 wherein the solid fluorinated polymer electrolyte membrane is a perfluorinated polymer.

13. The direct methanol fuel cell of claim 12 wherein the perfluorinated polymer comprises a carbon backbone and at least one side chain represented by the formula —(OCF₂CFR_{f})ₐ—OCF₂CFR′_{f}SO₃Y, wherein R_{f} and R′_{f} are independently selected from F, Cl or a perfluorinated alkyl group having 1 to 10 carbon atoms, a=0, 1 or 2, and Y is H, an alkali metal, or NH₄.

14. The direct methanol fuel cell of claim 12 wherein the perfluorinated polymer comprises a carbon backbone and at least one side chain represented by the formula —O—CF2CF2SO3H, or a salt thereof.

15. The direct methanol fuel cell of claim 13 wherein the polymer has an IXR of about 17 to about 29.

16. The direct methanol fuel cell of claim 14 wherein the polymer has an IXR of about 17 to about 29.

17. The direct methanol fuel cell of claim 15 wherein the polymer has an IXR of about 23.
